(19) United States
(12) Patent Application Publication
(10) Pub. No.: US 2011/0082756 A1
(43) Pub. Date: Apr. 7, 2011

(54) ADVERTISING PRODUCT, AND A SYSTEM AND METHOD FOR IMPLEMENTING THE ADVERTISING PRODUCT

(75) Inventors: Matthew Eisnor, Boston, MA (US); Dusan Koljensic, Somerville, MA (US); Ryan Scott, Wayland, MA (US)

(73) Assignee: SAPIENT, INC., Boston, MA (US)

(21) Appl. No.: 12/899,358

(22) Filed: Oct. 6, 2010

Related U.S. Application Data
(60) Provisional application No. 61/249,233, filed on Oct. 6, 2009.

(51) Int. Cl. G06Q 30/00; G06Q 90/00

(52) U.S. Cl. 705/14.69; 705/500

(57) ABSTRACT

A method. The method is implemented at least in part by a computing device. The method includes receiving, at the computing device, an offer to procure a paid placement advertisement in an advertising campaign, wherein the advertising campaign comprises a free inclusive portion and a paid placement portion. The method also includes evaluating the offer, wherein the evaluating is performed by the computing device. The method further includes allocating available paid placement advertisements based on the evaluated offer, wherein the allocating is performed by the computing device.

### CROSS-REFERENCE TO RELATED APPLICATION

This application claims the benefit under 35 U.S.C. §119(e) of the earlier filing date of U.S. Provisional Patent Application No. 61/249,233 filed on Oct. 6, 2009, and incorporates by reference the entirety of the contents thereof.

### BACKGROUND

This application discloses an invention which is related, generally and in various embodiments, to an advertising product, to a system for implementing the advertising product, and to a method for implementing the advertising product.

In today's society, there are a multitude of venues where there are large groups of people who are prime targets for a variety of advertisements. Examples of such venues include, for example, airports, railway stations, casinos, resorts, shopping malls, sports arenas, etc. In many of these venues, there are a significant number of parties who can benefit from placing advertisements which reach the prime targets.

However, because traditional advertising platforms only provide access and/or placements to those advertisers who are willing to pay the most for the available advertisements, many parties who could otherwise benefit from such access and/or placements fail to realize the benefits associated with the advertisements. When utilized in venues where there are many such parties, the traditional advertising platforms often work to the detriment of the majority of parties because a relatively small number of parties often secure the available advertisements. Thus, for a venue such as an airport where the collective health and vitality of the various concessionaires has a direct impact on the health and vitality of the airport itself, the traditional advertising platforms are often less than ideal.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of an advertising product;

FIG. 2 illustrates various embodiments of a system;

FIG. 3 illustrates various embodiments of a computing system of the system of FIG. 2; and

FIG. 4 illustrates various embodiments of a method.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

As described in more detail hereinbelow, aspects of the invention may be implemented by a computing device and/or a computer program stored on a computer-readable medium. The computer-readable medium may comprise a disk, a device, and/or a propagated signal.

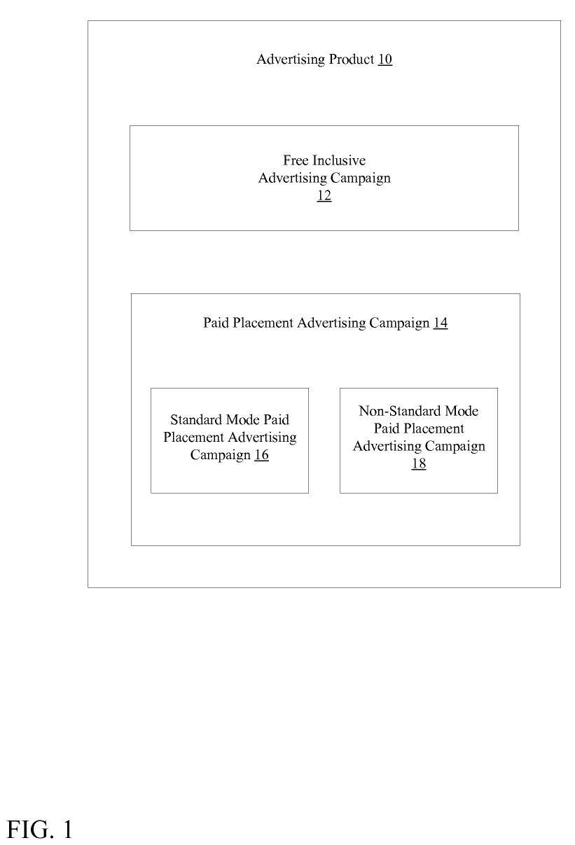

FIG. 1 illustrates various embodiments of an advertising product 10. The advertising product 10 includes a free inclusive advertising campaign 12 and a paid placement advertising campaign 14. The advertising product 10 is suitable for venues such as, for example, airports, railway stations, casinos, resorts, shopping malls, sports arenas, etc. which typically host large groups of people. According to various embodiments, the advertising product 10 may be utilized concurrently in a plurality of venues. For example, according to various embodiments, the advertising product 10 may be utilized concurrently in a plurality of airports. According to other embodiments, the advertising product 10 may be utilized concurrently in a plurality of different venues (e.g., airports, railway stations, casinos, etc.). For purposes of simplicity, the advertising product 10 will be described primarily in the context of its utilization for an airport. However, it will be appreciated that the advertising product 10 may be utilized in any number of different venues.

In general, for a given venue and a given channel, a number of placements are available with certain attributes for a given time period via the advertising product 10, and the available placements are split between the free inclusive advertising campaign 12 and the paid placement advertising campaign 14. The placements may include any number of different placement types such as, for example, a banner advertisement placed in the header portion of a web page, a banner advertisement placed in an edge portion of a web page, a paid placement within a web page, a text advertisement, a rich media advertisement, a promotion, an offer code, a barcode, etc. The placements may be available for any number of different channels, and the channels may include, for example, a web site, a mobile device, a digital display, a kiosk, etc. According to various embodiments, placements may also be utilized to affect search results and/or other text placements. According to various embodiments, the respective splits total 100% of the available placements (e.g., 20% for the free inclusive advertising campaign 12 and 80% for the paid placement advertising campaign 14), and the respective splits between the free inclusive advertising campaign 12 and the paid placement campaign 14 may vary over time. For embodiments where the advertising product 10 is utilized in a plurality of venues, the respective splits may also vary from venue to venue. It will be appreciated that the advertising product 10 may be utilized to present a plurality of different placements via a plurality of different channels at a plurality of different venues.

With respect to the free inclusive advertising campaign 12, according to various embodiments, for a given venue, all of the vendors, concessionaires, etc. who typically operate in the venue are eligible to participate in the free inclusive advertising campaign 12. The free inclusive advertising campaign 12 places a certain number of advertisements for each participant at no charge. In general, the advertisements for the free inclusive advertising campaign 12 may include different placement types (e.g., a banner advertisement placed in the header portion of a web page, a banner advertisement placed in an edge portion of a web page, a paid placement within a web page, a text advertisement, a rich media advertisement, a promotion, an offer code, a barcode, etc.), and the advertisements are placed in a variety of different channels (e.g., a website, a smart phone application, an interactive display, a wayfinding display, etc.). It will be appreciated that some channels (e.g., a smart phone application) may be utilized across a plurality of venues. According to various embodiments, the total number of advertisements available via the free inclusive advertising campaign 12 represents a percentage of the total advertisements available via the advertising product 10. In other words, according to various embodiments, a percentage of the total advertisements available via the advertising product 10 are reserved for the free inclusive advertising campaign 12. For a given venue, the percentage reserved for the free inclusive advertising campaign 12 may be set at an initial percentage, and may be subsequently changed to different values at different subsequent times. Thus, it will be appreciated that the percentage reserved for the free inclusive advertising campaign 12 for a given venue may be considered to be configurable. For embodiments where the advertising product 10 is utilized in a plurality of venues, the percentage of advertisements reserved for the free inclusive advertising campaign 12 for one venue may be different than the percentage reserved for another venue, and the respective percentages may be changed over time.

With respect to the paid placement advertising campaign 14, according to various embodiments, participation in the paid placement advertising campaign 14 is open to all potential advertisers. Thus, for a given venue, all of the vendors, concessionaires, etc. who are eligible to participate in the free inclusive advertising campaign 12 are also eligible to participate in the paid placement advertising campaign 14. The paid placement advertising campaign 14 provides an opportunity for each vendor, concessionaire, etc. to procure advertisements in addition to those reserved for the free inclusive advertising campaign 12. Also, according to various embodiments, parties who are not eligible to participate in the free inclusive advertising campaign 12 are nonetheless eligible to participate in the paid placement advertising campaign 14. Such parties may include, for example, parties who are located away from a given venue, parties who have national brands, etc. For embodiments where the advertising product 10 is utilized in a plurality of venues, such parties may include parties who are located at one of the other venues. According to various embodiments, parties located at another venue in which the advertising product 10 is utilized may enjoy placement priority over parties who are not located at one of the venues in which the advertising product 10 is utilized. Such placement priorities may include, for example, different pricing requirements, different maximum allocations, etc. In general, the advertisements realized via the paid placement advertising campaign 14 may include different placement types such as, for example, a banner advertisement placed in the header portion of a web page, a banner advertisement placed in an edge portion of a web page, a paid placement within a web page, a text advertisement, a rich media advertisement, a promotion, an offer code, a barcode, etc. The paid placement advertisements may be realized via a variety of different channels, including any of the channels that are indicated hereinabove for the free advertisements.

In general, the percentage of advertisements reserved for the paid placement advertising campaign 14 are split between the parties who are eligible to participate in the free inclusive advertising campaign 12 and the parties who are not eligible to participate in the free inclusive advertising campaign 12. For example, if 80% of the total advertisements available via the advertising product 10 are reserved for the paid placement advertising campaign 14, 60% of the total advertisements available via the advertising product 10 may be reserved for the parties who are eligible to participate in the free inclusive advertising campaign 12, and the remaining 20% of the total advertisements available via the advertising product 10 may be reserved for the parties who are not eligible to participate in the free inclusive advertising campaign 12. Thus, for this example, 20% of the total advertisements available via the advertising product 10 are reserved for the free inclusive advertising campaign 12, 60% of the total advertisements available via the advertising product 10 are reserved for the paid placement advertising campaign participants who are eligible to participate in the free inclusive advertising campaign 12, and 20% of the total advertisements available via the advertising product 10 are reserved for the paid placement advertising campaign participants who are not eligible to participate in the free inclusive advertising campaign 12. The respective percentages are configurable, can vary over time, and can vary between venues. It will also be appreciated that the respective percentages can vary by channel within a given venue.

According to various embodiments, the paid placement advertising campaign 14 includes a standard mode paid placement advertising campaign 16 and a non-standard mode paid placement advertising campaign 18. Both the standard mode paid placement advertising campaign 16 and the non-standard mode paid placement advertising campaign 18 may be open to all potential advertisers. For such embodiments, the paid placement advertisements available via the standard mode paid placement advertising campaign 16 are realized when the given venue is operating at a standard condition whereas the paid placement advertisements available via the non-standard mode paid placement advertising campaign 18 are realized when the given venue is operating at a non-standard condition. Examples of a non-standard condition include instances when a flight is delayed, an event which draws an unusually large crowd, etc. The non-standard mode paid placement advertising campaign 18 may be utilized, for example, to allow a concessionaire located at an airport to target travelers affected by the occurrence of an event within a specific location in the airport. Such locations may include, for example, a specific gate, a specific terminal, an entire airport, etc. A given event associated with a non-standard operating condition can be a large scale event (e.g., an airport closing) which can have a dramatic impact on a large number of travelers, or a smaller scale event (e.g., a cancellation of a single flight) which can have a more limited impact on a relatively small number of travelers in a specific location of the airport.

In view of the above, it will be appreciated that according to various embodiments, various advertising attributes are available for the paid placement advertising campaign 14. Using an airport venue as an example, the available advertising attributes may include, for example, events (e.g., flight, weather, airport, etc.), location based attributes, time based attributes, etc. In a non-airport venue, the available advertising attributes may include, for example, events (e.g., weather, holiday, special event, etc.), location based attributes (e.g., mall wings, stores, venue levels, etc.), time based attributes, other attributes (e.g., players on field, score of game, slot jackpots, etc.).

According to various embodiments, the paid placement advertising campaign 14 may be utilized to allow an advertiser to add one or more attributes to a base advertisement type in order to target specific consumers who are most likely to act on the advertisement. The advertiser may have any number of attributes added to a base advertisement type. In return for having a more highly targeted advertisement delivered to consumers, the advertiser may be required to pay a premium for each targeting attribute that is added to the base advertisement type. The premium for a given added attribute may be the same as or different than the premium for another given added attribute.

According to various embodiments, each attribute that is added to the base advertisement type has a predetermined prioritization ranking associated therewith. The sum of the prioritization rankings for each attribute may be calculated for each advertisement unit to determine an advertisement unit attribution score which determines the order in which all advertisement units (both base advertisement units and attributed advertisement units) are served. For example, when an advertiser purchases a base advertisement type of “Homepage Banner” and adds the attributes “day of week”, “day part”, “flight event” and “concourse”, the advertiser may be required to pay the base price for the “Homepage Banner” plus an addition 10% premium for each attribute that was added to the base advertisement type. In this example, if the “Homepage Banner” price was $10 per 1000 impressions, the advertiser may be required to pay $14 per 1000 impressions for the highly targeted advertisement with the four selected attributes. Of course, it will be appreciated that the premium for a given attribute may be a value other than 10% of the base price of the base advertisement type.

According to various embodiments, a potential advertiser may request that a particular type of standard mode advertisement (e.g., a banner advertisement placed in the header portion of a web page, a banner advertisement placed in an edge portion of a web page, a paid placement within a web page, a text advertisement, a rich media advertisement, a promotion, an offer code, a barcode, etc.) be presented in a particular channel during a given period by submitting an offer which includes a maximum price that the potential advertiser is willing to pay to have the advertisement presented in the particular channel, and a maximum count which represents the maximum number of times that the potential advertiser is willing to have the advertisement presented in the particular channel.

It will be appreciated that, according to various embodiments, the potential advertiser may request that the particular type of standard mode advertisement be presented on a plurality of different channels during the given period. For such embodiments, the offer may indicate a respective maximum price and a corresponding maximum count for each type of placement for each channel. The maximum price may be expressed in any suitable manner. For example, according to various embodiments, the maximum price indicated in the offer represents the maximum price per 1000 impressions of the advertisement. According to other embodiments, the maximum price may represent the maximum price the potential advertiser is willing to pay for each advertisement click, the maximum price the potential advertiser is willing to pay for each advertisement redemption, etc. Thus, it will be appreciated that a number of different revenue models may be utilized with the advertising product 10.

The maximum count may also be expressed in any suitable manner. For example, according to various embodiments, the maximum count indicated in the offer represents a percentage of all of the standard mode advertisements which are expected to be available for the particular type of standard mode advertisement for the particular channel during the given period. Because the standard mode paid placement advertising campaign 16 may include any number of different types of placements (e.g., a banner advertisement placed in the header portion of a web page, a banner advertisement placed in an edge portion of a web page, a paid placement within a web page, a text advertisement, a rich media advertisement, a promotion, an offer code, a barcode, etc.) which can be placed in any number of different channels, an offer may include a respective maximum price and a corresponding maximum count for each different standard mode advertisement placement type for each different channel. According to various embodiments, an advertising offer includes the following: a venue where the advertisement will be shown, a channel where the advertisement will be shown, a placement of the advertisement, a standard or non-standard condition, and a plurality including, but not limited to, a day of the week, a time of the day, a location in the venue, a proximity to a gate, an origination city, a destination city, etc. Thus, it will be appreciated that an offer may include a plurality of maximum prices and corresponding maximum counts, and a plurality of attributes.

Similarly, according to various embodiments, a potential advertiser may request that a particular type of non-standard mode advertisement placement (e.g., a banner advertisement placed in the header of a web page) be presented in a particular channel when a particular non-standard operating condition exists (e.g., an airport closure, a terminal closure, a flight cancellation, etc.) during a given period by submitting an offer which includes a maximum price that the potential advertiser is willing to pay to have the advertisement presented in the particular channel, and a maximum count which represents the maximum number of times that the potential advertiser is willing to have the advertisement presented in the particular channel. For example, a concessionaire who wants to target large numbers of travelers across a given airport may submit an offer for advertisements which are to be realized during a non-standard operating condition that is large scale and impacts the entire airport, whereas a concessionaire who wants to target small numbers of travelers close to their concession location may submit an offer for advertisements which are to be realized during a non-standard operating condition that is small scale and only impacts a particular area of the airport. Of course, the concessionaire may also select various attributes to target travelers when a venue is operating in a standard operating condition.

For the offer associated with the non-standard paid placement advertising campaign 18, the maximum price may be expressed in any suitable manner. For example, according to various embodiments, the maximum price indicated in the offer represents the maximum price per 1000 impressions of the advertisement. According to other embodiments, the maximum price may represent the maximum price the potential advertiser is willing to pay for each advertisement click, the maximum price the potential advertiser is willing to pay for each advertisement redemption, etc. Thus, it will be appreciated that a number of different revenue models may be utilized with the advertising product 10. The maximum count may also be expressed in any suitable manner. For example, according to various embodiments, the maximum count indicated in the offer represents a percentage of all of the standard mode advertisements which are expected to be available in the particular channel for the particular type of non-standard mode advertisement during the given period. Because the non-standard mode paid placement advertising campaign 16 may include any number of different types of placements which can be placed for any number of different channels during any number of different non-standard operating conditions, an offer may include a maximum price and a maximum count for each different combination of placement type, channel, and non-standard operating condition. Thus, it will be appreciated that an offer may include a plurality of maximum prices and corresponding maximum counts.

In general, for a given venue, a potential advertiser may submit an offer for a standard paid placement advertisement (e.g., for a particular placement type for a particular channel), a non-standard paid placement advertisement (e.g., a particular placement type for a particular channel for a particular non-standard operating condition), and combinations thereof. For embodiments where the offer includes an offer for both a standard paid placement advertisement and a non-standard paid placement advertisement, the offer includes a maximum price and a maximum count for at least one standard paid placement advertisement, and a maximum price and a maximum count for at least one non-standard paid placement advertisement. Of course, such an offer may include any number of maximum prices and corresponding maximum counts.

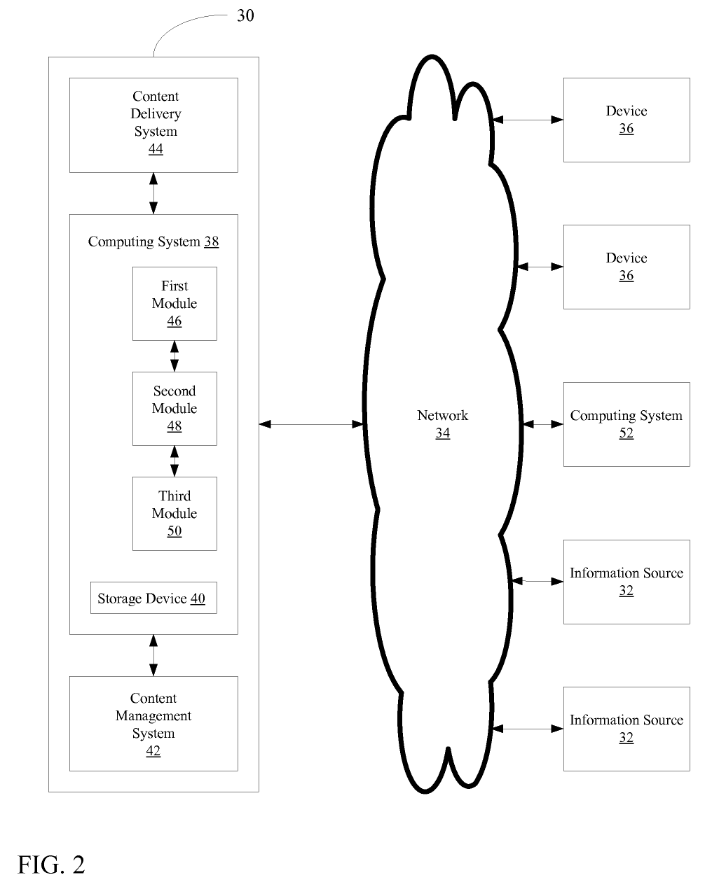

FIG. 2 illustrates various embodiments of a system 30. As explained in more detail hereinafter, the system 30 may be utilized to implement the advertisement product 10 described hereinabove. For purposes of simplicity, the system 30 will be described in the context of an advertisement product 10 for an airport. However, it will be appreciated that the system 30 may be utilized to implement an advertising product 10 for venues such as, for example, casinos, railway stations, resorts, shopping malls, sports arenas, etc. and combinations thereof.

The system 30 is communicably connected to a plurality of different information sources 32 via a wired or wireless pathway, or as shown in FIG. 2, via a network 34 having wired or wireless data pathways. Such information sources 32 may include, for example, a flight information source, a gate information source, a baggage claim information source, a lodging information source, a concessionaire information source, a ground transportation information source, a weather information source, etc. The information sources 32 may be provided by a venue (e.g., an airport) or from a source external to the venue.

The system 30 is also communicably connected to a plurality of different devices 36 via wired or wireless pathways, or as shown in FIG. 2, via the network 34. Such devices 36 may include for example, a web server, a wireless device (e.g., a smart phone), an interactive display, a wayfinding display, etc., and may be utilized to display an advertisement. The devices 36 may also be utilized to display information that the system 30 receives from the information sources 32.

The network 34 may include any type of delivery system including, but not limited to, a local area network (e.g., Ethernet), a wide area network (e.g. the Internet and/or World Wide Web), a telephone network (e.g., analog, digital, wired, wireless, PSTN, ISDN, GSM, GPRS, and/or xDSL), a packet-switched network, a radio network, a television network, a cable network, a satellite network, and/or any other wired or wireless communications network configured to carry data. The network 34 may include elements, such as, for example, intermediate nodes, proxy servers, routers, switches, and adapters configured to direct and/or deliver data. In general, the system 30 may be structured and arranged to communicate with the information sources 32 and the devices 36 via the network 34 using various communication protocols (e.g., HTTP, TCP/IP, UDP, WAP, WiFi, Bluetooth) and/or to operate within or in concert with one or more other communications systems.

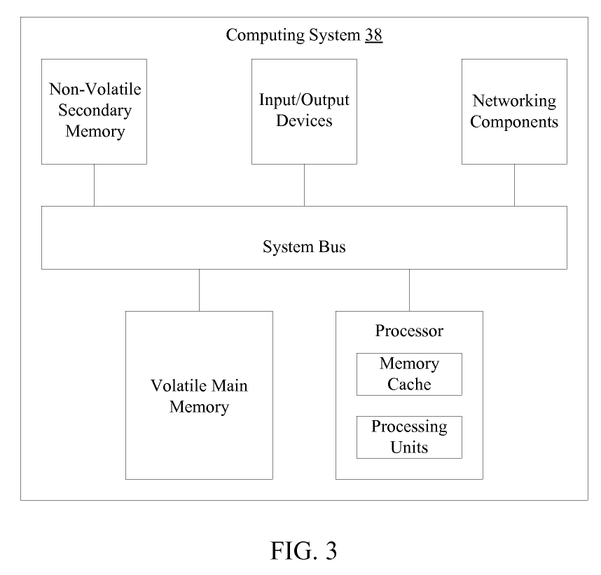

The system 30 includes a computing system 38 communicably connected to the system 30. The computing system 38 may be any suitable type of computing system that includes a processor (e.g., a server, a desktop, a laptop, etc.). For purposes of simplicity, the processor is not shown in FIG. 2. Various embodiments of the computing system 38 are described in more detail hereinbelow with respect to FIG. 3.

The system 30 also includes a storage device 40 communicably connected to the computing system 38. According to various embodiments, the storage device 40 is integral to the computing system 38. According to other embodiments, the storage device 40 is separate from the computing system 38. According to various embodiments, the system 30 may also include a content management system 42 and a content delivery system 44. The content management system 42 is communicably connected to the computing system 38, and is communicably connected to the information sources 32 via the network 34. The content delivery system 44 is communicatively connected to the computing system 38, and is communicably connected to the devices 36 via the network 34.

The system 30 also includes a first module 46 communicably connected to the processor, a second module 48 communicably connected to the processor, and a third module 50 communicably connected to the processor. The first module 48 is configured for receiving an offer for procuring a paid placement advertisement in an advertising campaign which includes a free inclusion portion and a paid placement portion. As described hereinabove, the offer may include any number of respective maximum prices and corresponding maximum counts associated with standard paid placements and non-standard paid placements. The second module 48 is communicably connected to the first module 46, and is configured for evaluating the offer. It will be appreciated that the second module 48 is configured to evaluate any number of respective maximum prices and corresponding maximum counts associated with standard paid placements and non-standard paid placements. According to various embodiments, the second module 48 is also configured to evaluate the effect that acceptance of the offer would have on a budget of the advertiser who submitted the offer. The third module 50 is communicably connected to the second module 48, and is configured for allocating available paid placement advertisements based on the evaluated offer. According to various embodiments, if acceptance of the offer would result in the budget of the advertiser being exceeded, the allocation is not carried out by the third module 50. As described hereinabove, the available advertisements include standard paid placement advertisements (e.g., for a particular placement type for a particular channel) and non-standard paid placement advertisement (e.g., a particular placement type for a particular channel for a particular non-standard operating condition).

The modules 46, 48, 50 may be implemented in hardware, firmware, software and combinations thereof. For embodiments utilizing software, the software may utilize any suitable computer language (e.g., C, C++, Java, JavaScript, Visual Basic, VBScript, Delphi, .NET, etc.) and may be embodied permanently or temporarily in any type of machine, component, physical or virtual equipment, storage medium, or propagated signal capable of delivering instructions to a device. The modules 46, 48, 50 (e.g., software application, computer program) may be stored on a computer-readable medium (e.g., disk, device, and/or propagated signal) such that when a computer reads the medium, the functions described herein are performed.

Although only one computing system 38 and one storage device 40 are shown in FIG. 2, it will be appreciated that the system 30 may include any number of computing systems 38 and storage devices 40. For embodiments where the system 30 includes more than one computing system 38, the modules 46, 48, 50 may be distributed across the plurality of computing systems 38. According to various embodiments, any of the functionality of the system 30 as described herein may be realized by one or more of the modules 46, 48, 50 (or by similar modules not shown in FIG. 2 for purposes of simplicity), and the functionality of any such modules may be combined into fewer modules or into a single module.

According to various embodiments, at least some of the advertisements delivered by the system 30 are location based advertisements. For example, for instances where the venue is an airport and a consumer is traveling through the airport, the system 30 may be utilized to deliver advertisements to a wireless device associated with the consumer, where the delivered advertisements relate to both the airport and the anticipated path of the consumer through the airport (i.e., the advertisements are spatially relevant). The system 30 may be utilized to determine the anticipated path of the consumer through the airport by, for example, analyzing flight numbers and departing/arriving gate numbers associated with the consumer.

According to various embodiments, the system 30 may also be utilized to control who advertisements are presented to, how the revenue generated by the advertisements is distributed, etc. For example, for embodiments where the advertising product 10 is utilized in a plurality of airports, the system 30 may be configured to block certain advertisements from being presented to a traveler as the traveler travels from a first airport (e.g., an originating airport) to a second airport (e.g., a connecting airport) to a third airport (e.g., a destination airport). For example, the system 30 may permit advertisements associated with an originating airport, a connecting airport, and a destination airport to be presented to a traveler as the traveler travels from one of the airports to the other, but may block or prevent advertisements associated with a different airport from being presented to the traveler. Also, for embodiments where the advertising product 10 is utilized in a plurality of airports, the system 30 may be configured to splits revenues from the various advertisements amongst the originating airport, any connecting airports, and the destination airport. It will be appreciated that the revenues may be split in any number of different ways.

Additionally, according to various embodiments, the system 30 may also be utilized to control the presentation of advertisements across venue types. For example, when a casino is a venue, and the only advertisements the casino desires its patrons to focus on are advertisement s associated with the casino, the system 30 may be utilized to serve all advertisements associated with the casino to a wireless device associated with a patron of the casino, but block all incoming advertisements associated with venues other than the casino.

From the perspective of the advertiser, the system 30 may be utilized to control how much money the advertiser will spend on any placement, campaign, or during any time period. For example, the system 30 may be utilized to set a monthly dollar spending limit for the advertiser, and/or to set a monthly impression, click or redemption limit. Thus, it will be appreciated that the system 30 may be utilized to set budgets for the advertisers, and such budgets may be set, for example, at the placement level or at the campaign level (i.e., multiple placements). The budgets can also be set separately for campaigns associated with a standard operating condition or a non-standard operating condition.

As shown in FIG. 2, the system 30 may also be communicably connected to a computing system 52 via the network 34. The computing system 52 may be utilized by an advertiser to purchase advertising to be delivered by the system 30. As part of the purchasing process, the computing system 52 may be utilized by the advertiser to, among other things, view available advertising inventory, view historical pricing for advertising inventory, place an offer, and view the status of the offer (e.g., highest bid, lowest bid). Although only one computing system 52 is shown in FIG. 2, it will be appreciated that any number of computing systems 52 may be communicably connected to the system 30.

According to various embodiments, the system 30 may be utilized to offer various discounts associated with the paid placement advertising campaign 14 to the advertisers. The discount may be embodied in any suitable form and/or in any suitable amount. For example, the discount may be a 5% discount, a 10% discount, a 15% discount, etc. The discounts may be utilized with both the standard mode paid placement advertising campaign 16 and the non-standard mode paid placement advertising campaign 18. The discounts may also be utilized with both undersold and oversold conditions. The discounts may be offered to advertisers for a variety of reasons, such as, for example, for buying paid placement advertisements in bulk, for buying paid placement advertisements by a certain deadline, for agreeing to prompt payment of invoices, etc. The discounts operate to reduce the actual price that an advertiser will pay for one or more portions of the paid placement advertising campaign 14, and may serve as an incentive for the advertiser to commit to a more substantial purchase. In view of the above, it will be appreciated that the actual price paid by the advertiser (the “paid price”) will be lower than the non-discounted price (the “system price”).

For such embodiments, the system 30 is configured to separately handle both the system price and the paid price. According to various embodiments, the system 30 utilizes the system price to determine the frequency that the paid placement advertising campaign 14 is run. However, when the system 30 determines the advertiser's cost for the paid placement advertising campaign 14, the system 30 utilizes the paid price to do so.

For example, in a first scenario where an advertiser wants to buy 10,000 impressions of the ABC campaign unit at $10 CPM (cost per 1000 impressions) for a total campaign cost of $100, the system 30 may opt to not offer the advertiser a discount (e.g., a 0% discount) due to the relatively low volume. For this case, the system price and the paid price are the same (i.e., $10 CPM). The system 30 will utilize the $10 CPM system price to determine the frequency that the ABC campaign unit is run (relative to all the purchased paid placement advertisements of the paid placement advertising campaign 14), and will utilize the $10 CPM paid price to determine the total campaign cost to be $100.

In contrast, in a second scenario where an advertiser wants to buy 100,000 impressions of the ABC campaign unit at $10 CPM for a total campaign cost of $1000, the system 30 may opt to offer the advertiser a 10% (or other) discount due to the relatively high volume. For this case, where the offered discount is 10%, the system price and the paid price are different from one another. The system price is $10 CPM and the paid price is $9 CPM (90% of the $10 CPM system price). The system 30 will utilize the $10 CPM system price to determine the frequency that the ABC campaign unit is run (relative to all the purchased paid placement advertisements of the paid placement advertising campaign 14), and will utilize the $9 CPM paid price to determine the total campaign cost to be $900. The $900 cost is what the advertiser will be invoiced, and represents a $100 reduction from what the campaign cost would have been but for the 10% discount.

FIG. 3 illustrates various embodiments of the computing system 38. The computing system 38 may be embodied as one or more computing devices, and includes networking components such as Ethernet adapters, non-volatile secondary memory such as magnetic disks, input/output devices such as keyboards and visual displays, volatile main memory, and a processor. Each of these components may be communicably connected via a common system bus. The processor includes processing units and on-chip storage devices such as memory caches.

According to various embodiments, the computing system 38 includes one or more modules which are implemented in software, and the software is stored in non-volatile memory devices while not in use. When the software is needed, the software is loaded into volatile main memory. After the software is loaded into volatile main memory, the processor reads software instructions from volatile main memory and performs useful operations by executing sequences of the software instructions on data which is read into the processor from volatile main memory. Upon completion of the useful operations, the processor writes certain data results to volatile main memory.

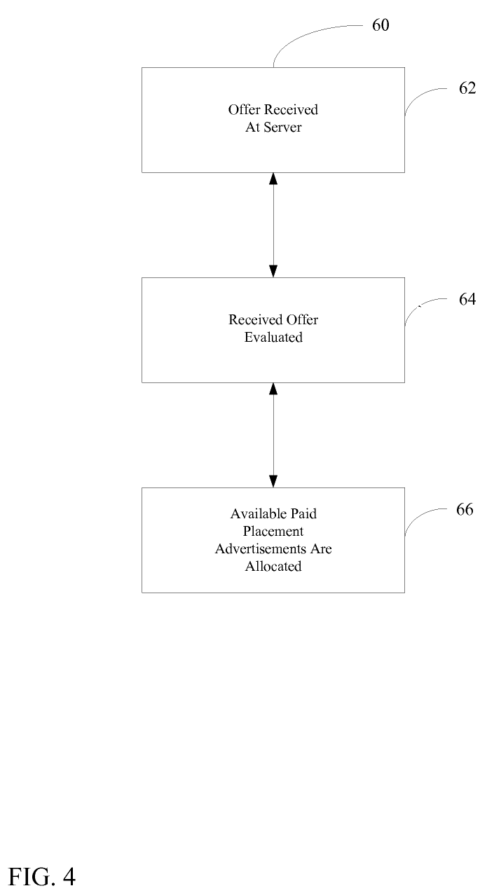

FIG. 4 illustrates various embodiments of a method 60. As described in more detail hereinafter, the method 60 may be utilized to implement the advertising product 10 described hereinabove. The method 60 is implemented at least in part by a computing device, and may be implemented by the system 30 of FIG. 2. For purposes of simplicity, the method 60 will be described in the context of being implemented by the system 30 of FIG. 2. However, it will be appreciated that the method 60 may be implemented by a system other than system 30.

Prior to the start of the process, a free inclusive advertising campaign is created for the vendors/concessionaires of a given venue. The respective vendors/concessionaires are assigned to various categories (e.g., food, retail, news, service, etc.), then individual free inclusive advertising campaigns are created for each category. The free inclusive advertising campaigns are created in a way that will meet the needs of both the given category and the unique needs of the advertiser. The free inclusive advertising campaigns that are created for each category may include more than one free inclusive advertising campaign for a given category. For example, the free inclusive advertising campaign created for one vendor within a given category may differ from the free inclusive advertising campaign created for another vendor in the given category.

Some parameters regarding the standard mode paid placement advertising campaign 16 and the non-standard mode paid placement advertising campaign 18 are also established prior to the start of the process. For example, for the standard mode paid placement campaign, a respective predetermined minimum price and a corresponding predetermined maximum allocation may be established for each different type of placement for each channel and for each venue. For the non-standard mode paid placement advertising campaign paid 18, a respective predetermined minimum price and a corresponding predetermined maximum allocation may be established for each respective combination of placement type, channel, and non-standard operating condition. It will be appreciated that the predetermined minimum price may be different for different placement types and different channels, and may be different for different combinations of placement type, channel, non-standard operating condition and venue. The respective allocation percentages for the free inclusive advertising campaign 12 and the paid placement advertising campaign 14 may also be determined prior to the start of the process.

Additionally, offers to procure paid placement advertisements are submitted by various parties (e.g., a vendor, a concessionaire, a hotel representative, a car rental representative, a national retailer, etc.) for placements in one or more channels and one or more venues. As described hereinabove, each offer may be an offer to procure standard paid placement advertisements, non-standard paid placement advertisements, or combinations thereof. The offers may be submitted concurrently or at different times prior to the start of the process. In general, the offers are submitted to the system 30 via the network 34.

The process starts at block 62, where the first module 46 of the server 38 receives a submitted offer. It is understood that a plurality of such offers may be received at block 62. The information in the offer may be stored at storage device 40 for any period of time.

From block 62, the process advances to block 64, where the offer received at block 62 is evaluated by the second module 48 of the server 38. According to various embodiments, the evaluation includes comparing a maximum price indicated in the offer to a predetermined minimum price, and comparing a corresponding maximum count indicated in the offer to a predetermined maximum allocation. According to various embodiments, the evaluation includes comparing a plurality of maximum prices and maximum counts indicated in the offer to corresponding predetermined minimum prices and predetermined maximum allocations. Some of the maximum price/maximum count information may be associated with the standard mode paid placement advertising campaign 16, and some of the maximum price/maximum count information may be associated with the non-standard paid placement advertising campaign 18. According to various embodiments, the evaluation also includes determining the effect that acceptance of the offer will have on a budget of the advertiser who submitted the offer. For embodiments where a discount is associated with the offer, the discount is taken into account when determining the effect that acceptance of the offer will have on the budget of the advertiser who submitted the offer. It is understood that a plurality of offers may be evaluated at block 64.

From block 64, the process advances to block 66, where the available paid placement advertisements are allocated by the third module 50 of the server 38 based on the evaluated offer. According to various embodiments, if acceptance of the offer would result in the budget of the advertiser being exceeded, the allocation is not carried out at block 66. The allocations may be made in any number of different ways, but the third module 50 is generally configured to make the allocations in a way which encourages a greater number of the eligible parties to participate in the paid placement advertising campaign 14. According to various embodiments, when a given maximum price indicated in the offer is less than the associated predetermined minimum price for a given placement, the request for the given placement may be eliminated from consideration. For example, if a maximum price indicated in the offer for a given placement type for a given channel for a standard paid placement advertisement is less than the associated predetermined minimum price, the advertising request for the given placement type for the given channel may be eliminated from consideration.

Also, according to various embodiments, when a maximum allocation indicated in the offer is greater than the associated predetermined maximum allocation for a given placement, the party who submitted the offer may be assigned an allocation for the given placement which is less than or equal to the predetermined maximum allocation. According to other embodiments, when the available placements for a given standard or non-standard paid placement advertisement are undersold, and the associated maximum allocation indicated in the offer is greater than the corresponding predetermined maximum allocation, the party who submitted the offer may be assigned an allocation for the particular standard or non-standard paid placement advertisement which is greater than the predetermined maximum allocation.

According to various embodiments, once the maximum prices and the requested maximum allocations have been evaluated for each received offer, the requested maximum allocations are totaled for each different combination of placement type and channel for the standard condition to determine, for each respective combination, whether the combination is undersold or oversold. Similarly, the requested maximum allocations are totaled for each different combination of placement type, channel, and non-standard condition to determine, for each respective combination, whether the combination is oversold or undersold. As described hereinabove, when a given maximum price indicated in an offer is less than the associated predetermined minimum price for a given placement, the request for the given placement may be eliminated from consideration. For such offers, the requested maximum allocation indicated in the offer for the given placement may be ignored when totaling the requested maximum allocation for the placement.

According to various embodiments, when it is determined that an undersold condition exists for a particular placement, each party who submitted an offer that indicated a corresponding maximum price greater than or equal to the associated predetermined minimum price may be assigned an allocation at the predetermined minimum price. For a given party, the assigned allocation may be equal to the maximum count indicated in the offer, may be limited to the predetermined maximum allocation, or may be increased to an amount which is greater than the maximum count indicated in the offer. In some instances, the assigned allocation may be increased to an amount which is greater than the predetermined maximum allocation. According to various embodiments, the additional advertisements will be placed at no charge to the given party.

According to other embodiments, when it is determined that an undersold condition exists for a particular placement, each party who submitted an offer that indicated a corresponding maximum price greater than or equal to the associated predetermined minimum price may be assigned an allocation for the particular placement at the lowest maximum price submitted by the respective parties. For a given party, the assigned allocation may be equal to the maximum count indicated in the offer, may be limited to the predetermined maximum allocation, or may be increased to an amount which is greater than the maximum count indicated in the offer. In some instances, the assigned allocation may be increased to an amount which is greater than the predetermined maximum allocation. According to various embodiments, the additional advertisements will be placed at no charge to the given party.

Any difference between the amount of available advertisements and the actual amount of advertisements allocated by the above-described process may be considered remnant inventory, and such inventory may be allocated in any number of different ways. For example, the remnant inventory for a particular placement may be allocated to all of the parties who participate in the free inclusive advertising campaign 12, to only those parties who participate in the paid placement advertising campaign 14, and combinations thereof by increasing the predetermined maximum allocation, by selling the remnant inventory to an ad network, by increasing the allocation reserved for participants in the paid placement advertising campaign 14 who are not eligible to participate in the free inclusive advertising campaign 12, any combination of the above, etc. According to various embodiments, the remnant inventory may be sold to the eligible participants as remnant advertising. According to other embodiments, the remnant inventory may be allocated to the eligible participants at no charge.

According to various embodiments, when it is determined that an oversold condition exists for a particular placement, each party who submitted an offer that indicated a maximum price greater than or equal to the predetermined minimum price will receive an allocation. According to various embodiments, the allocation for a given party for the particular placement is at the maximum price indicated in their offer. According to other embodiments, the allocation for a given party may be at a price which is less than the maximum price indicated in their offer. For example, a given party who submits an offer with the highest maximum price for a particular placement may be assigned an allocation at a lower maximum price submitted by a second party in a second offer.

According to various embodiments, the party who submitted the offer with the highest maximum price for a given placement is assigned an allocation which is equal to the maximum count indicated in their offer if the maximum count is less than or equal to the predetermined maximum allocation. According to other embodiments, the party who submitted the offer with the highest maximum price for a given placement is assigned an allocation which is less than the maximum count indicated in their offer if the maximum count is greater than the predetermined maximum allocation.

The allocations other than the allocation assigned to the party who submitted the highest maximum price may be assigned in any number of different ways to the other parties who submitted offers which indicated a maximum price greater than or equal to the predetermined minimum price. For example, according to various embodiments, the remaining allocations may be divided equally amongst the other parties, and allocated to the respective parties at the respective maximum prices indicated in their offers. According to other embodiments, the remaining allocations may be made based on a weighted average allocation. For such embodiments, a weighted average allocation for a particular placement may be determined for a given party based on the following formula:

WAA=(MP of Party/SMP)×(100−RMA of Party with HMP)

where WAA is the weighted maximum allocation, MP is the maximum price indicated in the offer submitted by the given party for the given placement, SMP is the sum of all of the maximum prices other than the maximum price of the party who submitted the highest maximum price, RMA is the maximum count indicated in the offer, and HMP is the highest maximum price.

The process described at blocks 62-66 may be repeated any number of times.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the described invention. Accordingly, it is understood that the drawings and the descriptions herein are proffered only to facilitate comprehension of the invention and should not be construed to limit the scope thereof.

1. An advertising product, comprising:
a free inclusive advertising campaign configured to place at least one advertisement for each participant at no charge; and
a paid placement advertising campaign configured to place a paid placement advertisement for at least one of the participants.

2. The advertising product of claim 1, wherein:
a total of the advertisements designated for the free inclusive advertising campaign comprises a first percentage of all advertisements associated with the advertising product; and
a total of the advertisements designated for the paid placement advertising campaign comprises a second percentage of all available advertisements associated with the advertising product.

3. The advertising product of claim 1, wherein the paid placement advertising campaign comprises:
a standard mode paid placement advertising campaign configured to place a second paid placement advertisement for a second one of the participants when a venue associated with the advertising product is operating at a standard condition; and
a non-standard mode paid placement advertising campaign configured to place a third paid placement advertisement for a third one of the participants when a venue associated with the advertising product is operating at a non-standard condition.

4. The advertising product of claim 1, further comprising a second paid placement advertising campaign configured to place a second paid placement advertisement for a party who is not eligible to participate in the free inclusive advertising campaign.

5. The advertising product of claim 4, wherein:
a total of the advertisements designated for the free inclusive advertising campaign comprises a first percentage of all advertisements associated with the advertising product;
a total of the advertisements designated for the paid placement advertising campaign comprises a second percentage of all available advertisements associated with the advertising product; and
a total of the advertisements designated for the second paid placement advertising campaign comprises a third percentage of all available advertisements associated with the advertising product.

6. The advertising product of claim 6, wherein at least one of the following is a location based advertisement:
the at least one advertisement; and
the paid placement advertisement.

7. A system, comprising:
a computing device having a processor, wherein the computing device comprises:
a first module communicably connected to the processor, wherein the first module is configured to receive an offer to procure a paid placement advertisement in an advertising campaign which comprises a free inclusive portion and a paid placement portion;
a second module communicably connected to the processor, wherein the second module is configured to evaluate the offer; and
a third module communicably connected to the processor, wherein the third module is configured to allocate available paid placement advertisements based on the evaluated offer.

8. The system of claim 7, wherein the second module is further configured to determine how acceptance of the offer affects a budget of a party associated with the offer.

9. The system of claim 7, further comprising a storage device communicably connected to the computing device.

10. The system of claim 7, further comprising a content management system communicably connected to the computing device.

11. The system of claim 7, further comprising a content delivery system communicably connected to the computing device.

12. The system of claim 7, further comprising:
a content management system communicably connected to the computing device; and
a content delivery system communicably connected to the computing device.

13. A method, implemented at least in part by a computing device, the method comprising:
at the computing device, receiving an offer to procure a paid placement advertisement in an advertising campaign, wherein the advertising campaign comprises a free inclusive portion and a paid placement portion;
evaluating the offer, wherein the evaluating is performed by the computing device; and
allocating available paid placement advertisements based on the evaluated offer, wherein the allocating is performed by the computing device.

14. The method of claim 13, wherein receiving the offer comprises receiving a plurality of offers to procure paid placement advertisements in the advertising campaign.

15. The method of claim 13, wherein receiving the offer comprises receiving an offer associated with a participant in the free inclusive portion of the advertising campaign.

16. The method of claim 13, wherein receiving the offer comprises:
receiving a first maximum price and a first maximum count for a standard condition paid placement advertisement; and
receiving a second maximum price and a second maximum count for a non-standard condition paid placement advertisement.

17. The method of claim 16, wherein receiving the first maximum count for the standard paid placement advertisement comprises receiving a maximum allocation percentage for the standard paid placement advertisement.

18. The method of claim 16, wherein receiving the second maximum count for the non-standard paid placement advertisement comprises receiving a maximum allocation percentage for the non-standard paid placement advertisement.

19. The method of claim 13, wherein evaluating the offer comprises comparing a maximum price indicated in the offer to a predetermined minimum price.

20. The method of claim 13, wherein evaluating the offer comprises comparing a maximum count indicated in the offer to a predetermined maximum allocation.

21. The method of claim 13, wherein evaluating the offer comprises:
comparing a maximum price indicated in the offer to a predetermined minimum price; and
comparing a maximum count indicated in the offer to a predetermined maximum allocation.

22. The method of claim 13, wherein evaluating the offer comprises determining how acceptance of the offer affects a budget of a party associated with the offer.

23. The method of claim 13, wherein determining how acceptance of the offer affects the budget comprises determining a discount associated with the paid placement advertisement.

24. The method of claim 13, wherein allocating the available paid placement advertisements comprises allocating the available paid placement advertisements in a plurality of channels.

25. The method of claim 13, wherein allocating the available paid placement advertisements comprises allocating the available paid placement advertisements across a plurality of venues.

26. The method of claim 13, wherein allocating the available paid placement advertisements comprises:
allocating the available paid placement advertisements in a plurality of channels; and
allocating the available paid placement advertisements across a plurality of venues.

27. The method of claim 13, wherein allocating the available paid placement advertisements comprises allocating zero paid placement advertisements to a party associated with the offer when a maximum price indicated in the offer is less than a predetermined minimum price.

28. The method of claim 13, wherein allocating the available paid placement advertisements comprises allocating at least one paid placement advertisement to a party associated with the offer when a maximum price indicated in the offer is not less than a predetermined minimum price.

29. The method of claim 13, wherein allocating the available paid placement advertisements comprises allocating a maximum count indicated in the offer at a predetermined minimum price to a party associated with the offer when:
a maximum price indicated in the offer is not less than the predetermined minimum price;
the maximum count indicated in the offer is not greater than a predetermined maximum allocation; and
the available paid placement advertisements are undersold.

30. The method of claim 29, further comprising allocating at least some of any remaining available paid placement advertisements at the predetermined price to a second party associated with a second received offer when a maximum price indicated in the second offer is not less than the predetermined minimum price.

31. The method of claim 13, wherein allocating the available paid placement advertisements comprises allocating a maximum count indicated in the offer to a party associated with the offer at a second maximum price indicated in a second received offer when:
a maximum price indicated in the offer is not less than a predetermined minimum price;
the maximum count indicated in the offer is not greater than a predetermined maximum allocation;
the maximum price indicated in the offer is greater than the second maximum price indicated in the second received offer; and
the available paid placement advertisements are undersold.

32. The method of claim 31, further comprising allocating at least some of any remaining available paid placement advertisements to a second party associated with the second received offer at the second maximum price.

33. The method of claim 13, wherein allocating the available paid placement advertisements comprises allocating a maximum count indicated in the offer at a maximum price indicated in the offer to a party associated with the offer when:
the maximum price indicated in the offer is not less than the predetermined minimum price;
the maximum count indicated in the offer is not greater than a predetermined maximum allocation;
the maximum price indicated in the offer is greater than respective maximum prices indicated in other received offers; and
the available paid placement advertisements are oversold.

34. The method of claim 33, further comprising allocating at least some of any remaining paid placement advertisements at a second maximum price indicated in a second received offer to a second entity associated with the second offer when the second maximum price is not less than the predetermined minimum price.

35. The method of claim 33, further comprising allocating the at least some of any remaining available paid placement advertisements equally amongst a plurality of parties.

36. The method of claim 33, further comprising allocating the at least some of any remaining available paid placement advertisements based on a weighted average.

37. The method of claim 13, further comprising providing free inclusive advertising to a plurality of parties.

38. The method of claim 13, further comprising allocating free inclusive advertisements to a plurality of parties.

39. The method of claim 13, further comprising charging a cost per impression for each impression of a paid placement advertisement.

40. The method of claim 13, further comprising charging a cost per click for each time that a paid placement advertisement is clicked on.

41. The method of claim 13, further comprising charging a cost per redemption for each time a promotion in a paid placement advertisement is redeemed.
